(19) United States
(12) Patent Application Publication
(10) Pub. No.: US 2005/0173671 A1
(43) Pub. Date: Aug. 11, 2005

(54) Single-part photographic bleach-fixing composition

(75) Inventors: Yasufumi Nakai, Fort Lee, NJ (US); Hai-Xing Wan, Ramsey, NJ (US)

Correspondence Address: BURNS DOANE SWECKER & MATHIS L L P, POST OFFICE BOX 1404, ALEXANDRIA, VA, 22313-1404, US

(73) Assignees: FUJI HUNT PHOTOGRAPHIC CHEMICALS, INC. and; FUJI PHOTO FILM CO., LTD.

(21) Appl. No.: 10/772,341

(22) Filed: Feb. 6, 2004

(51) Int. Cl. C09K 3/00

(52) U.S. Cl. 252/186.1

(57) ABSTRACT

A single-part photographic bleach-fixing composition is provided which is formed by mixing at least a bleaching agent which includes an iron-ligand complex, a fixing agent including a thiosulfate, and at least one of a formula (A) compound or a formula (B) compound. Also provided are methods for processing a photographic material.

### BACKGROUND OF THE INVENTION

1. Field of the Invention

The present invention relates to a single-part photographic bleach-fixing composition. The single-part photographic bleach-fixing composition is suitable for use in the processing of a photographic silver halide material.

2. Description of the Related Art

A color image can be obtained from an exposed photographic silver halide material by processing such material with various photochemicals. For example, a photographic color developing composition can typically be used to process a color photographic material, such as a color photographic film or paper, which can result in the formation of a dye image and metallic silver. The metallic silver can typically be removed to obtain a useful color image. For example, the silver can be removed by oxidizing the silver using a bleaching agent, and the oxidized silver and undeveloped silver halide can be dissolved using a fixing agent. The bleaching agent and fixing agent can be present in a single bleach-fixing composition.

Various photochemicals used to process the photographic material including, for example, the bleaching and fixing agents, are often reactive with each other. Such reactions can have an adverse effect on photographic processing performance. In order to decrease or eliminate the occurrence of such undesirable reactions, the bleach-fixing composition can be formed from various “parts” which are separately maintained prior to use. Each separate part can contain one or more of the photochemicals for forming the bleach-fixing composition. For example, due to the reaction which can occur between the bleaching agent and the fixing agent, the bleaching and fixing agents can be maintained in separate parts and combined a short time or immediately prior to use.

However, maintaining separate parts for forming the bleach-fixing composition can be an inconvenience and requires separate packaging for each part. In addition, in order to ensure proper photographic processing performance, the separate parts typically should be added in specific proportions, which can be an additional burden on the technician preparing the bleach-fixing composition. In view of the above, it can be desirable to provide a single-part bleach-fixing composition which contains multiple photochemicals including, for example, the bleaching and fixing agents, in a single composition. Using a single-part bleach-fixing composition which already contains various photochemicals in proper proportions can ameliorate or eliminate the inconvenience and possible error caused by separately maintaining various photochemical parts, and manually measuring the photochemical parts.

One drawback of using a conventional single-part bleach-fixing composition is that a precipitate often forms during the storage of such composition. For example, the formation of the precipitate can be caused by a reaction between the photochemicals present in the composition. Generally, the presence of the precipitate during photographic processing can have an undesirable effect on processing performance. For example, the precipitate can become attached to the processed photographic material, causing scratches and/or other undesirable marks on the image. In addition, the precipitate can interfere with processing equipment, for example, by clogging processor filters and/or mechanical gears, which can lead to equipment damage and/or the requirement of equipment maintenance.

In view of the above, it can be beneficial to provide means of reducing or eliminating the formation of a precipitate in a single-part bleach-fixing composition. In an exemplary embodiment, the present invention can provide a single-part bleach-fixing composition in which the formation of a precipitate is reduced or eliminated. Other aspects of the present invention will become apparent to one of ordinary skill in the art upon review of the specification and claims appended hereto.

### SUMMARY OF THE INVENTION

According to one aspect of the present invention, a single-part photographic bleach-fixing composition is provided which is formed by mixing at least the following:
(a) a bleaching agent comprising an iron-ligand complex;
(b) a fixing agent comprising a thiosulfate; and
(c) at least one of the following formula (A) compound or formula (B) compound: 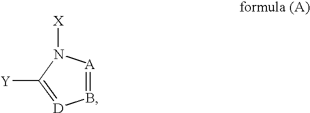
wherein each of A, B and D independently represents a nitrogen atom or C—R₅, wherein R₅ represents a hydrogen atom, an alkyl group, an aryl group, an amino group, a carboxyl group or a mercapto group; X represents a hydrogen atom, an alkyl group or an aryl group; and Y represents a hydrogen atom, an alkyl group, an aryl group, an amino group, a carboxyl group or a mercapto group; wherein R₅ is substituted or unsubstituted when R₅ is not the hydrogen atom, X is substituted or unsubstituted when X is not the hydrogen atom, and Y is substituted or unsubstituted when Y is not the hydrogen atom; 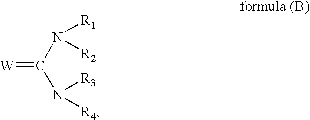
wherein W represents an oxygen atom, a sulfur atom or N—H; each of R₁, R₂, R₃ and R₄ independently represents a hydrogen atom, an alkyl group or an aryl group; wherein R₂ and R₃ are optionally bonded together to form a ring; and wherein R₁ is substituted or unsubstituted when R₁ is not the hydrogen atom, R₂ is substituted or unsubstituted when R₂ is not the hydrogen atom, R₃ is substituted or unsubstituted when R₃ is not the hydrogen atom, and R₄ is substituted or unsubstituted when R₄ is not the hydrogen atom.

Also provided is a method for processing a photographic material, which comprises contacting the photographic material with the single-part photographic bleach-fixing composition described above.

### DETAILED DESCRIPTION OF THE PREFERRED EMBODIMENTS OF THE INVENTION

The present invention provides a single-part bleach-fixing composition for use in processing a photographic material, and methods for processing a photographic material. In an exemplary embodiment, a single-part bleach-fixing concentrate is provided which can be stored for a prolonged period of time with little or substantially no formation of a precipitate therein. For example, use of the single-part bleach-fixing concentrate can reduce or eliminate formation of an iron-containing precipitate which often forms in compositions which employ an iron-ligand complex as a bleaching agent.

For example, the bleach-fixing composition can be substantially free of precipitate after a 4-week storage period during which the composition is not stirred. As used herein, the term “substantially free of precipitate” means that no precipitate is visible to the naked eye. Exemplary storage stability characteristics of the inventive composition are discussed below in greater detail in the Examples.

As used herein, the term “single-part” refers to a composition which is formed by mixing multiple photographic chemicals including, for example, at least the bleaching agent and the fixing agent. Preferably, the single-part composition can at least be formed from the photochemicals necessary for providing a functional bleach-fixing composition.

The bleach-fixing composition can be provided in the form of a concentrate, for example, a liquid concentrate. As used herein, the term “concentrate” refers to a composition which can be used to form a working-strength, photographic bleach-fixing composition by diluting such concentrate with a predetermined amount of a diluting medium, for example, water. The concentrate can be formed from photochemicals used in concentrations greater than the concentrations used in the working bleach-fixing composition. Since the concentrate can occupy a considerably smaller volume than the working composition, the formation of such concentrate can facilitate transporting, packaging and/or handling thereof. When the concentrate is ready for use, the concentrate can be diluted with water or other diluting medium to form the working composition. For example, the concentrate can be diluted with water in a concentrate-to-water ratio of from about 2:1 to about 1:3, preferably about 1:1, based on the volume of the concentrate and the water used. The concentrate-to-water ratio can depend on, for example, the amount of water that is used to form the concentrate.

The bleach-fixing composition is formed by mixing various components together including, for example, a bleaching agent, a fixing agent and at least one of the formula (A) compound or the formula (B) compound. Such components can be mixed together using any suitable method. As used herein, the “mixing” of the components includes the mere contact of the components with each other. The components can be contacted with each other in any order, or can be simultaneously contacted with each other. For example, the components can be mixed by simply adding the components to a receptacle. Optionally, the resulting composition can be stirred for a predetermined amount of time to ensure thorough mixing of the components. In one embodiment, the fixing agent is initially provided and optionally mixed with a sulfite, and thereafter the bleaching agent is mixed therewith.

The bleaching agent which can be used in the formation of the bleach-fixing composition can include any material which is effective to oxidize metallic silver. For example, the bleaching agent can include an iron-ligand complex, and more preferably, a ferric iron-ligand complex. The ferric iron-ligand complex can be formed from, for example, ethylenediaminedisuccinic acid (preferably s,s-form), N-(2-carboxylatoethyl)-L-aspartic acid, P-alaninediacetic acid, methyliminodiacetic acid, ethylenediaminetetraacetic acid, diethylenetriaminepentaacetic acid, 1,3-propylenediaminetetraacetic acid or salts thereof. Mixtures of the above compounds can also be employed. Additional ferric iron-ligand complexes which can be used in the present invention are described in U.S. Pat. No. 6,605,420, the entire contents of which are incorporated by reference herein.

The bleaching agent can be used in an amount which is effective to enable the composition to be capable of at least partially oxidizing metallic silver. In an exemplary embodiment, the bleaching agent can be used in an amount of at least about 0.1 mol/liter, preferably from about 0.1 to about 1.2 mol/liter, more preferably from about 0.15 to about 1.0 mol/liter, and most preferably from about 0.25 to about 0.8 mol/liter, based on the total volume of the composition.

The fixing agent used in the formation of the bleach-fixing composition can include any material which is effective to at least partially dissolve oxidized silver and/or undeveloped silver halide of the photographic material. For example, the fixing agent can include a thiosulfate. Exemplary thiosulfates include ammonium thiosulfate, sodium thiosulfate, potassium thiosulfate or mixtures thereof.

The fixing agent can be employed in an amount effective to at least partially dissolve the oxidized silver and/or the undeveloped silver halide of the photographic material. For example, the fixing agent can be used in an amount of at least about 0.5 mol/liter, preferably from about 0.5 to about 4.0 mol/liter, more preferably from about 1.0 to about 3.0 mol/liter, and most preferably from about 1.5 to about 2.5 mol/liter, based on the volume of the composition.

The bleach-fixing composition can be formed by employing the following formula (A) compound:

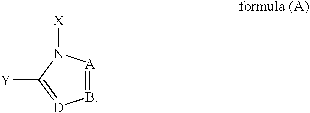

In the formula (A) compound, A, B and D can each independently represent a nitrogen atom or a C—R₅ group. The R₅ substituent in the C—R₅ group can represent a hydrogen atom, an alkyl group, an aryl group, an amino group, a carboxyl group or a mercapto group. In the case where two or three of A, B and D is represented by C—R₅, the R₅ substituents can be the same or different. In preferred embodiments, D can represent the nitrogen atom, and B can represent the C—R₅ group. Preferably, A can represent a C—H group.

In the formula (A) compound, the X substituent can represent a hydrogen atom, an alkyl group or an aryl group. The Y substituent can represent a hydrogen atom, an alkyl group, an aryl group, an amino group, a carboxyl group or a mercapto group.

R₅ can be substituted or unsubstituted when R₅ is not the hydrogen atom, X can be substituted or unsubstituted when X is not the hydrogen atom, and Y can be substituted or unsubstituted when Y is not the hydrogen atom. For example, X, Y and R₅ can each independently represent —CH₃, —C₆H₅ (phenyl) or —CH₂CH₂N(CH₃)₂. The phenyl group can be substituted, for example, in the following manner:

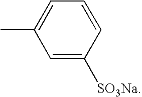

Additionally or alternatively, the bleach-fixing composition can be formed by employing the following formula (B) compound:

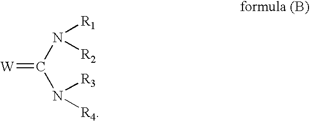

In the formula (B) compound, W can represent an oxygen atom, a sulfur atom or an N—H group, preferably the oxygen atom. R₁, R₂, R₃ and R₄ can each independently represent a hydrogen atom, an alkyl group or an aryl group. R₁ can be substituted or unsubstituted when R₁ is not the hydrogen atom, R₂ can be substituted or unsubstituted when R₂ is not the hydrogen atom, R₃ can be substituted or unsubstituted when R₃ is not the hydrogen atom, and R₄ can be substituted or unsubstituted when R₄ is not the hydrogen atom.

In an exemplary embodiment, each of R₁, R₂ and R₃ can represent a hydrogen atom and, more preferably, each of R₁, R₂, R₃ and R₄ can represent a hydrogen atom. Additionally or alternatively, one or more of R₁, R₂, R₃ and R₄ can represent —C₁H₃, —C₂H₅ or —C₆H₅. Optionally, R₂ and R₃ can be bonded together to form a ring. For example, R₂ and R₃ can form a five- or six-membered heterocyclic ring such as one of the following:

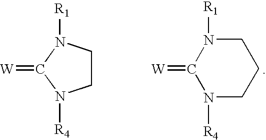

The bleach-fixing composition can be formed by employing the formula (A) compound, the formula (B) compound or a mixture thereof. Preferably, the composition can be formed using an amount of the formula (A) and/or formula (B) compound that is effective to reduce or prevent the formation of a precipitate in the composition. For example, the formula (A) compound and/or formula (B) compound can be employed in an amount from about 0.01 to about 5.0 mol/liter, preferably from about 0.05 to about 2.0 mol/liter, and more preferably from about 0.10 to about 1.0 mol/liter, based on the volume of the composition. In an exemplary embodiment, use of such formula (A) compound and/or formula (B) compound can result in a bleach-fixing composition which is substantially free from the formation of a precipitate after 30 days. As used herein, the term “substantially free of a precipitate” means that no precipitate in the composition is visible to the naked eye. This exemplary aspect of the present invention is discussed in greater detail in the examples set forth below.

Exemplary compounds of the formula (A) and formula (B) compounds are set forth below:

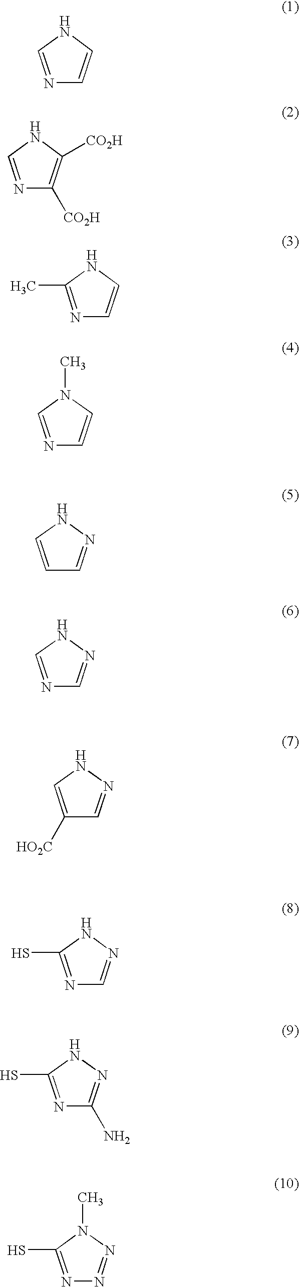

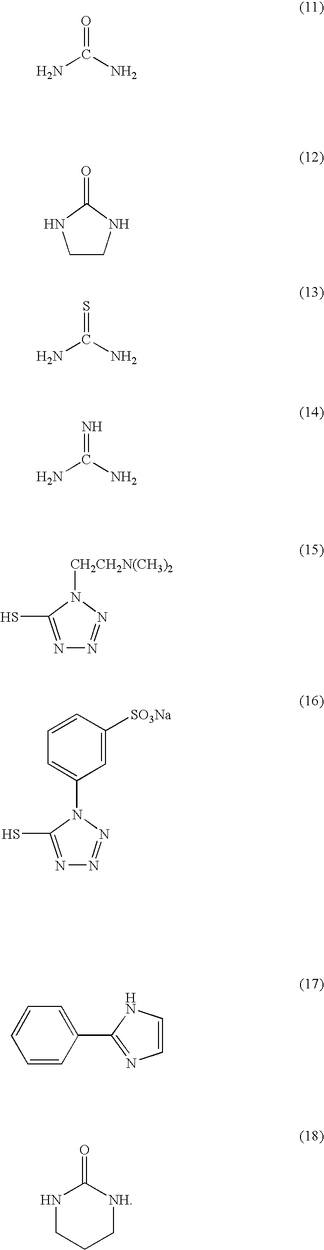

The at least one formula (A) or formula (B) compound can include any combination of the above exemplary compounds (1) to (18). Preferably, the at least one formula (A) or formula (B) compound can include the above compounds (1), (6), (11) or mixtures thereof.

The bleach-fixing composition can be in liquid form, and is preferably in the form of an aqueous solution in which photochemicals are dissolved. For example, the bleach-fixing composition can be formed from water in an amount of about 50% to about 80%, preferably from about 55% to about 75%, more preferably from about 60% to about 70%, based on the total weight of the composition. The amount of water used can depend on, for example, the desired concentration of a concentrate to be formed.

The present bleach-fixing composition can include a pH-adjusting agent for adjusting the pH thereof. Maintaining the pH at a particular level can assist in maintaining the solubility of components used to form the concentrate and/or the stability of the concentrate. Maintaining the pH at a particular level can also enable adequate bleach-fixing processing of the photographic material. In an exemplary embodiment, the composition can be formed from employing an amount of the pH-adjusting agent which is effective to adjust the pH of the composition to from about 3.5 to about 7.5, preferably from about 4.0 to about 7.0, and more preferably from about 4.5 to about 6.5. The pH-adjusting agent can include, for example, sulfuric acid, nitric acid, acetic acid, succinic acid, hydrochloric acid, sodium hydroxide, potassium hydroxide, ammonium hydroxide or mixtures thereof. Preferably, the pH-adjusting agent includes nitric acid.

The bleach-fixing concentrate can also be formed by employing a sulfite such as, for example, ammonium sulfite, ammonium bisulfite, sodium sulfite, potassium sulfite, sodium metabisulfite, potassium metabisulfite or mixtures thereof. The sulfite can, for example, function as an anti-oxidant and/or a preservative for the fixing agent. In an exemplary embodiment, the sulfite can be used in an amount of at least about 0.2 mol/liter, preferably from about 0.2 to about 3.0 mol/liter, more preferably from about 0.4 to about 2.5 mol/liter, most preferably from about 0.8 to about 2.0 mol/liter, based on the volume of the composition.

The bleach-fixing composition can also include a buffer compound to maintain the pH of the composition, especially in the diluted working bleach-fix composition during processing. This buffer can minimize pH changes in the working bleach-fix solution that may occur due to carry-in of processing chemicals such as developer. The buffer can include, for example, triethanolamine, triisopropanolamine, tris(hydroxymethyl)methylamine, glycineamide or mixtures thereof. A preferred buffer can include triethanolamine.

According to an additional aspect of the present invention, a method for processing a photographic material is provided. The method includes contacting the photographic material with the single-part photographic bleach-fixing composition. For example, the bleach-fixing composition can be present in a bath, and the photographic material can be at least partially immersed into the bath. In an exemplary embodiment, the bleach-fixing composition can be provided in the form of a concentrate, and the bleach-fixing composition can be diluted prior to contact with the photographic material.

### EXAMPLES

Single-part bleach-fixing compositions according to aspects of the present invention and comparative compositions were prepared, and the storage stability of the compositions was tested by observing by the naked eye whether a precipitate formed therein during storage.

### Example 1

Each of Sample Nos. 1 to 8 was formed by mixing 1.59 mol ammonium thiosulfate, 0.61 mol ammonium bisulfite and 0.52 mol ferric ammonium EDTA. Sample No. 1 did not employ an additive. Sample Nos. 2 to 8 were also formed by adding an additive, wherein the particular additive and the amount of the additive used are set forth in Table 1. The pH of each of the samples was adjusted to 6.20 by adding ammonium hydroxide, and water was added to a final volume of 1 liter. The resulting samples were stirred.

The concentrates were stored without stirring for 2 days at 50° C. and then for 4 weeks at 4° C. The appearance of the concentrates was observed, and the results are set forth in Table 1. Sample Nos. 1 to 4 are comparative examples, and Sample Nos. 5 to 8 are in accordance with aspects of the present invention.

TABLE 1

| Sample | | Amt. of | |
|---|---|---|---|
| No. | Additive | Additive | Result |
| 1 | none | 0 g/L | precipitate formed |
| 2 | triethanolamine | 30 g/L | precipitate formed |
| 3 | piperazine anhydrate | 30 g/L | precipitate formed |
| 4 | morpholine | 30 g/L | precipitate formed |
| 5 | compound (1) | 30 g/L | clear, no precipitate formed |
| 6 | compound (6) | 30 g/L | clear, no precipitate formed |
| 7 | compound (7) | 15 g/L | clear, no precipitate formed |
| 8 | compound (11) | 60 g/L | clear, no precipitate formed |

As can be seen from Table 1, Sample Nos. 5 to 8 were clear and did not have any visible precipitate after the storage period, whereas Comparative Sample Nos. 1 to 4 formed a precipitate.

### Example 2

Each inventive concentrate (Sample Nos. 2 to 4) was formed by mixing 1.83 mol ammonium thiosulfate, 0.75 mol ammonium bisulfite, 0.39 mol ferric ammonium EDTA and an additive. The particular additive and the amount of the additive used are set forth in Table 2. The comparative concentrate (Sample No. 1) was formed by mixing 1.83 mol ammonium thiosulfate, 0.75 mol ammonium bisulfite, 0.39 mol ferric ammonium EDTA, without an additive. The pH of each of the samples was adjusted to 5.45 by adding sulfuric acid and ammonium hydroxide, and water was added to a final volume of 1 liter. The resulting concentrate was stirred.

The concentrates were stored without stirring for 2 days at 50° C. and then for 4 weeks at 4° C. The appearance of the concentrates was observed, and the results are set forth in Table 2. Sample No. 1 is a comparative example, and Sample Nos. 2 to 4 are in accordance with aspects of the present invention.

TABLE 2

| Sample | | Amt. of | |
|---|---|---|---|
| No. | Additive | Additive | Result |
| 1 | none | 0 g/L | precipitate formed |
| 2 | compound (1) | 20 g/L | clear, no precipitate formed |
| 3 | compound (6) | 10 g/L | clear, no precipitate formed |
| 4 | compound (11) | 30 g/L | clear, no precipitate formed |

As can be seen from Table 2, Sample Nos. 2 to 4 were clear and did not have any visible precipitate after the storage period, whereas Comparative Sample No. 1 which did not employ an additive formed a precipitate.

From the above examples, it can be seen that the present invention can provide a single-part bleach-fixing concentrate in which the formation of a precipitate after a prolonged storage period is reduced or eliminated.

While the invention has been described in detail with reference to specific embodiments thereof, it will be apparent to one skilled in the art that various changes and modifications can be made and equivalents employed without departing from the scope of the claims.

1. A single-part photographic bleach-fixing composition formed by mixing at least the following:
(a) a bleaching agent comprising an iron-ligand complex;
(b) a fixing agent comprising a thiosulfate; and
(c) at least one of the following formula (A) compound or formula (B) compound: 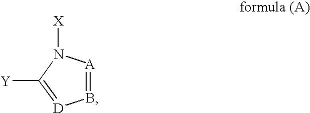
wherein each of A, B and D independently represents a nitrogen atom or C—R₅, wherein R₅ represents a hydrogen atom, an alkyl group, an aryl group, an amino group, a carboxyl group or a mercapto group; X represents a hydrogen atom, an alkyl group or an aryl group; and Y represents a hydrogen atom, an alkyl group, an aryl group, an amino group, a carboxyl group or a mercapto group; wherein R₅ is substituted or unsubstituted when R₅ is not the hydrogen atom, X is substituted or unsubstituted when X is not the hydrogen atom, and Y is substituted or unsubstituted when Y is not the hydrogen atom; 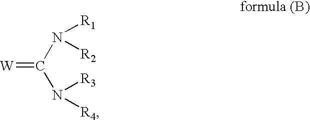
wherein W represents an oxygen atom, a sulfur atom or N—H; each of R₁, R₂, R₃ and R₄ independently represents a hydrogen atom, an alkyl group or an aryl group; wherein R₂ and R₃ are optionally bonded together to form a ring, and wherein R₁ is substituted or unsubstituted when R₁ is not the hydrogen atom, R₂ is substituted or unsubstituted when R₂ is not the hydrogen atom, R₃ is substituted or unsubstituted when R₃ is not the hydrogen atom, and R₄ is substituted or unsubstituted when R₄ is not the hydrogen atom.

2. The single-part photographic bleach-fixing composition according to claim 1, wherein the composition is formed from at least the formula (A) compound, and wherein D represents the nitrogen atom and B represents C—R₅.

3. The single-part photographic bleach-fixing composition according to claim 2, wherein A in the formula (A) compound represents C—H.

4. The single-part photographic bleach-fixing composition according to claim 1, wherein the composition is formed from at least the formula (B) compound, and wherein W represents the oxygen atom.

5. The single-part photographic bleach-fixing composition according to claim 1, wherein each of R₁, R₂ and R₃ of the formula (B) compound represents the hydrogen atom.

6. The single-part photographic bleach-fixing composition according to claim 5, wherein each of R₁, R₂, R₃ and R₄ of the formula (B) compound represents the hydrogen atom.

7. The single-part photographic bleach-fixing composition according to claim 1, wherein the bleaching agent is mixed in an amount of at least about 0.1 mol/liter, based on the volume of the composition.

8. The single-part photographic bleach-fixing composition according to claim 7, wherein the bleaching agent is mixed in an amount from about 0.1 to about 1.2 mol/liter, based on the volume of the composition.

9. The single-part photographic bleach-fixing composition according to claim 8, wherein the bleaching agent is mixed in an amount from about 0.15 to about 1.0 mol/liter, based on the volume of the composition.

10. The single-part photographic bleach-fixing composition according to claim 9, wherein the bleaching agent is mixed in an amount from about 0.25 to about 0.8 mol/liter, based on the volume of the composition.

11. The single-part photographic bleach-fixing composition according to claim 1, wherein the fixing agent consists essentially of the thiosulfate.

12. The single-part photographic bleach-fixing composition according to claim 1, wherein the fixing agent is mixed in an amount of at least about 0.5 mol/liter, based on the volume of the composition.

13. The single-part photographic bleach-fixing composition according to claim 12, wherein the fixing agent is mixed in an amount from about 0.5 to about 4.0 mol/liter, based on the volume of the composition.

14. The single-part photographic bleach-fixing composition according to claim 13, wherein the fixing agent is mixed in an amount from about 1.0 to about 3.0 mol/liter, based on the volume of the composition.

15. The single-part photographic bleach-fixing composition according to claim 14, wherein the fixing agent is mixed in an amount from about 1.5 to about 2.5 mol/liter, based on the volume of the composition.

16. The single-part photographic bleach-fixing composition according to claim 1, wherein the composition is further formed by mixing a sulfite.

17. The single-part photographic bleach-fixing composition according to claim 16, wherein the sulfite is mixed in an amount of at least about 0.2 mol/liter, based on the volume of the composition.

18. The single-part photographic bleach-fixing composition according to claim 17, wherein the sulfite is mixed in an amount from about 0.2 to about 3.0 mol/liter, based on the volume of the composition.

19. The single-part photographic bleach-fixing composition according to claim 18, wherein the sulfite is mixed in an amount from about 0.4 to about 2.5 mol/liter, based on the volume of the composition.

20. The single-part photographic bleach-fixing composition according to claim 19, wherein the sulfite is mixed in an amount from about 0.8 to about 2.0 mol/liter, based on the volume of the composition.

21. The single-part photographic bleach-fixing composition according to claim 1, wherein the at least one of the formula (A) compound or formula (B) compound is mixed in an amount from about 0.01 to about 5.0 mol/liter, based on the volume of the composition.

22. The single-part photographic bleach-fixing composition according to claim 21, wherein the at least one of the formula (A) compound or formula (B) compound is mixed in an amount from about 0.05 to about 2.0 mol/liter, based on the volume of the composition.

23. The single-part photographic bleach-fixing composition according to claim 22, wherein the at least one of the formula (A) compound or formula (B) compound is mixed in an amount from about 0.10 to about 1.0 mol/liter, based on the volume of the composition.

24. The single-part photographic bleach-fixing composition according to claim 1, wherein the pH of the composition is from about 3.5 to about 7.5.

25. The single-part photographic bleach-fixing composition according to claim 24, wherein the pH of the composition is from about 4.0 to about 7.0.

26. The single-part photographic bleach-fixing composition according to claim 25, wherein the pH of the composition is from about 4.5 to about 6.5.

27. The single-part photographic bleach-fixing composition according to claim 1, wherein the at least one of the formula (A) compound or formula (B) compound comprises a compound selected from the group consisting of the following compounds (1) to (18) and mixtures thereof:

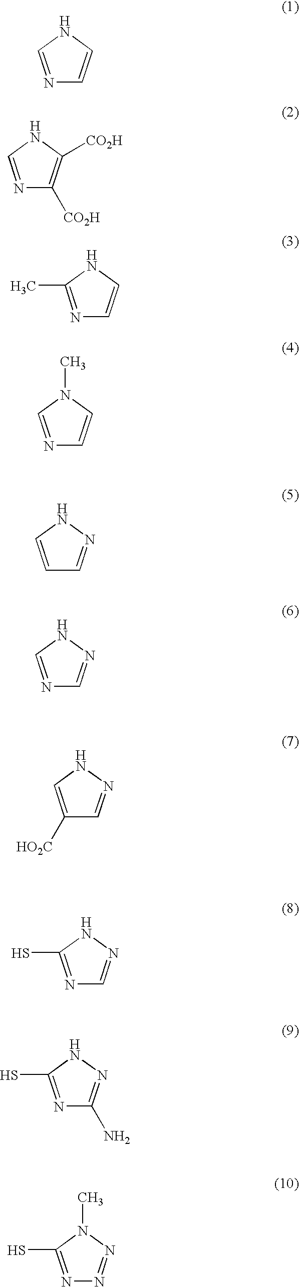

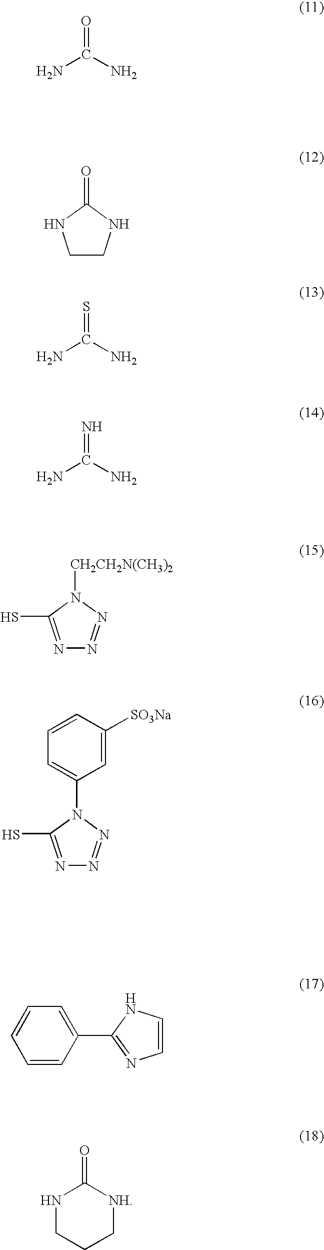

28. The single-part photographic bleach-fixing composition according to claim 27, wherein the at least one of the formula (A) compound or formula (B) compound comprises a compound selected from the group consisting of compounds (1), (6), (11) and mixtures thereof.

29. The single-part photographic bleach-fixing composition according to claim 1, wherein the composition is in the form of a concentrate.

30. A method for processing a photographic material, comprising contacting the photographic material with the single-part photographic bleach-fixing composition according to claim 1.

31. The method according to claim 30, wherein the single-part photographic bleach-fixing composition is in the form of a concentrate, and the concentrate is diluted prior to contact with the photographic material.
